(19) United States
(12) Patent Application Publication
(10) Pub. No.: US 2004/0192555 A1
(43) Pub. Date: Sep. 30, 2004

(54) Method of enhancing irrigation efficiency

(76) Inventors: Kevin Hawk, Eltopia, WA (US); James Meadows, Memphis, TN (US)

Correspondence Address: STINSON MORRISON HECKER LLP, ATTN: PATENT GROUP, 1201 WALNUT STREET, SUITE 2800, KANSAS CITY, MO, 64106-2150, US

(21) Appl. No.: 10/457,115

(22) Filed: Jun. 6, 2003

Related U.S. Application Data
(60) Provisional application No. 60/457,972, filed on Mar. 27, 2003.

(51) Int. Cl. A01N 25/10; A01N 25/02

(52) U.S. Cl. 504/361; 504/362

(57) ABSTRACT

The present invention is directed to a method for increasing irrigation efficiency by applying a non-surfactant, non-crosslinked water-soluble polymer to established turf to increase irrigation efficiency. The polymer is preferably a linear anionic high molecular weight polyacrylamide.

### CROSS-REFERENCE TO RELATED APPLICATIONS

This application is based on U.S. Provisional Application Serial No. 60/457,972, filed on Mar. 27, 2003, which is hereby incorporated herein by reference.

### STATEMENT REGARDING FEDERALLY SPONSORED RESEARCH OR DEVELOPMENT

Not Applicable.

### BACKGROUND OF THE INVENTION

1. Field of the Invention

This invention is directed to the field of turf management and is more specifically directed to a method for improving the efficiency of irrigation in established turf.

2. Description of Related Art

Water conservation is a major issue in the United States and other countries, as water becomes an increasingly expensive commodity. Turf, particularly managed turf such as that located at golf courses, athletic fields, office parks and similar areas, uses an immense amount of water. In recent surveys by the Golf Course Superintendents Association of America (GCSAA), respondents indicated that irrigating an eighteen hole golf course in the U.S., having an average area of 77.7 irrigated acres, required an average of 28.5 million gallons of water each year. Of course the survey indicated regional differences in irrigation demand, with the Southwest US requiring 88 million gallons of water per year while the Mid-Atlantic states required 10 million gallons of water on average.

Another problem facing areas of managed turf is localized dry spot (“LDS”) caused by water-repellent soil conditions. Although this hydrophobic soil condition has several possible causes, researchers generally agree that the formation of an organic coating on the soil particles caused by the decomposition of plants and/or organisms causes the problem. LDS is characterized by irregular and isolated areas of problematic turf grass on the golf course, in the lawn or in other areas of turf.

Generally, the symptoms of LDS are treated with surfactants, or surface-active agents. Some surfactants used to treat LDS are surfactant polymers. A surfactant polymer generally contains large segments or “blocks” of monomer which are hydrophobic in nature, attached to large blocks, which are hydrophilic in nature. Such surfactant polymers are generally referred to as “block copolymers” and give the polymer its surface-active nature. It is generally accepted that the hydrophobic portion of the surfactant molecule is attracted to the water repellent organic coating on the soil, whereas the hydrophilic portion of the surfactant remains readily accessible to water, thus allowing water to move into the soil profile, rather than running off of the surface.

A large number of surfactants are currently being marketed to manage LDS. Such products are often marketed as “soil wetters” or “wetting agents.” Wetting agents are materials that increase the area that a droplet of a given volume of spray mixture will cover on a target. The management approach for using soil wetters and wetting agents generally involves direct application of the agents to the localized, problematic area, on an as needed basis, as part of an overall LDS management program.

In addition to surfactants, super-absorbing cross-linked polymers, including cross-linked polyacrylamides, have been used to treat LDS. As the soil becomes wet, the cross-linked polymer absorbs water and holds it in the soil. Theoretically, the polymer continues to release stored water to the plant long after the soil would normally have dried. These cross-linked polymers can absorb and hold many times their weight in water.

### BRIEF SUMMARY OF THE INVENTION

The present invention is directed to the surprising discovery that a non-surfactant non-crosslinked water-soluble polymer can be applied to established turf to increase irrigation efficiency. The non-surfactant non-crosslinked water-soluble polymer is preferably a linear anionic polyacrylamide. It has been found that application of the polymer of the present invention to established turf unexpectedly increases the efficiency of turf irrigation. When used herein, the term increased “irrigation efficiency” encompasses any decrease in the need for irrigation or increase in the benefits derived from irrigation. For example, increased irrigation efficiency would encompass fewer irrigation cycles or a lower water requirement in each cycle to maintain healthy turf. It would also encompass increasing the benefit gained from an irrigation cycle, such as by increasing the overall health of turf under conditions that would otherwise produce stressed turf.

The water-soluble polymer utilized in the method of present invention is preferably a non-crosslinked polyacrylamide, more preferably an anionic polyacrylamide and most preferably a high molecular weight anionic polyacrylamide. Preferably the polymer is provided as an emulsion, which is added to irrigation water and applied to the established turf using an irrigation system. However, the polymer may be provided in any form, including in a solution or as a dry powder or granules.

The method of the present invention may be applied to any established turf, including areas of established turf suffering from localized dry spot. However, the method of the present invention is a general broad application management tool, which increases overall irrigation efficiency for healthy turf. The benefits of the present invention can be achieved in turf that is not suffering from localized dry spot, or turf in which a majority or substantial portion of the turf is not suffering from localized dry spot. The polymer is particularly useful when applied to managed turf, such as a golf course, athletic field, office park or similar area.

The non-surfactant, non-crosslinked water-soluble polymer of the present invention possesses properties that are very different from the properties exhibited by compounds traditionally marketed as soil wetters. Thus, the increased irrigation efficiency provided by the non-surfactant non-crosslinked water-soluble polymer of the present invention was truly unexpected. Unlike surfactants, the water-soluble polymer of the present invention does not act as a wetting agent. Further, unlike traditional soil wetters, which are designed to treat the hydrophobic soil of LDS, the water-soluble polymer of the present invention is not designed to address the hydrophobicity of soils that cause LDS. Although the mechanism of action is unclear, the water-soluble polymer of the present invention surprisingly increases the benefits of irrigation throughout the turf, to improve the overall health of the turf between irrigation cycles and to decrease required frequency or duration of the irrigation cycles to reduce the total amount of water used.

### DETAILED DESCRIPTION OF PREFERRED EMBODIMENT

The present invention is directed to a method for increasing irrigation efficiency by applying a non-surfactant, non-crosslinked water-soluble polymer, preferably a polyacrylamide, to established turf. Preferably the polymer is applied to the established turf through an irrigation system. Application of the polymer of the present invention to established turf has been shown to decrease the need for irrigation and to increase the overall health of the turf under harsh conditions.

The polymer utilized in the present invention is a non-surfactant, non-crosslinked water-soluble polymer. As used herein, the term “water-soluble” means the polymer dissolves readily in water acceptable for application to turf at a useful level. When used herein, the term “non-surfactant polymer” means a substance that does not decrease the surface tension of water to 50 dynes/cm or below at 0. 1% w/w ratio. A non-surfactant polymer is generally a chain of molecules derived from one or more monomers, having an insignificant content of hydrophobic monomers. Non-surfactant polymers may be structurally described as homopolymers; random copolymers, wherein all monomers are hydrophilic or the polymer does not contain large blocks of hydrophobic monomer, but rather any hydrophobic monomers are randomly ordered throughout the polymer in a low enough ratio that the polymer retains its water solubility; or block copolymers wherein all blocks are hydrophilic in nature. A “non-crosslinked polymer” is a polymer that is substantially free of cross-linking under standard conditions of use.

Polymers that can be used consistent with the present invention include, but are not limited to, non-crosslinked, non-surfactant water soluble polyacrylamides, polymers of acrylic acid, methacrylic acids and their salts, methacrylamides, polyacrylonitrile and its hydrolysis products, polyethylene oxides, polyalkyleneoxides, and copolymers, derivatives or mixtures of the foregoing. In the most preferred embodiment, the water-soluble polymer of the present invention is a linear polyacrylamide, more preferably an anionic linear polyacrylamide, and most preferably is a high molecular weight anionic linear polyacrylamide. When used herein, the term “polyacrylamide” is meant to include both polyacrylamide homopolymers and polyacrylamide co-polymers, unless otherwise specified. Most preferably the polyacrylamide is an acrylamide/sodium acrylate random copolymer.

Preferred water-soluble polymers have a high molecular weight, preferably over about 1,000 amu, more preferably over about 10,000,000 amu and most preferably between about 10,000,000 and 25,000,000 amu. Polymers of any charge may be used with the present invention, with anionic and nonionic polymers preferred and anionic polymers most preferred. Preferably the polymer has an anionic mole charge between about 1 and about 75%, more preferably between about 2 and about 55% and most preferably the mole charge of the polymer is between about 3 and about 40%.

The polymer of the present invention may be provided in any form, including as a powder, as granules, as a solution or as an emulsion. The polymer is preferably provided and applied in a formulation that is substantially free of surfactant. Alternatively, the formulation may contain a surfactant as a formulation aid, to allow the polymer to be incorporated into the formulation at a more concentrated level, such as in an emulsion. When a surfactant is used in a formulation, it is preferably present in an amount that does not affect the irrigation efficiency enhancing properties of the formulation. In one embodiment, the polymer is supplied as a concentrated liquid emulsion designed for rapid dispersion in water. Liquid polyacrylamide emulsions that may be used consistent with the invention include POLYTEX TEC sold by Exacto, Inc. out of Richmond, Ill. Polymers may also be provided in solutions, which generally contain low levels of polymers and no surfactants, but must be used at higher rates than the concentrated emulsions.

In the embodiment wherein the polymer is provided as an emulsion, the polymer emulsion is diluted with water and applied to established turf via an irrigation system. The irrigation water serves as a carrier for the polymer and can efficiently distribute the polymer to the targeted turf. Preferably the polymer emulsion is directly injected into a pressurized irrigation system during a normal irrigation cycle. In one embodiment, the injection pump is plumbed directly into the irrigation system at the water pumping station, downstream from the irrigation pump. As the polymer emulsion is injected into the irrigation system, it is mixed with the irrigation water to form a water/polymer mixture, which travels through the irrigation system and is ultimately applied to the turf via the sprinkler heads of the irrigation system. The polymer may be injected using a piston type injection pump or any other positive displacement injection system designed for metering small quantities of viscous materials. The Model I-70 single piston-type injection pump sold by Inject-O-Meter can be used consistent with the present invention.

Prior to injection, the injection system should be clean and dry. Purging the injection system with a mineral oil prior to injection can insure that all excess moisture is flushed form the system. Mineral oil can also be used to prime and calibrate the system and test the interlock with the irrigation system. Before initiating injection of the polymer, the irrigation system should be turned on and water flow confirmed. The polymer emulsion is preferably used at rates under 50 ppm. To achieve such use rates, the polymeric emulsion sold under the trademark POLYTEX TEC, can be mixed at the rate of 50 gallons emulsion to 1,000,000 gallons of water.

In an alternative embodiment, the polymer is provided in a dry form, such as a granular or powder from, applied directly to the turf and watered in, such as through irrigation.

Use rates and treatment schedule will vary based on a variety of factors, including soil type, environmental conditions, soil fertility levels, overall turf health, turf type, water quality, and irrigation system. Preferably the polymer of the present invention is applied at rates of about 1 to 12.5 pounds of polymer solids per 1000 square feet, as part of an overall management plan with scheduled application every 2 to 6 weeks, preferably every 30 days. Healthy turf will generally require an amount at the low end of the range, whereas turf suffering from poor irrigation will require amounts at the high end. The polymer of the present invention may be used with each irrigation cycle, but is preferably applied at regular intervals, with intermediate polymer-free irrigation cycles. In many areas, irrigation cycles are not repeated at regular intervals, but rather when the turf shows a predetermined amount of stress. When the polymer of the present invention is used, the turf does not show stress as quickly, and the length of time between irrigation cycles is increased. In addition, it is contemplated that the polymer may be applied at a high rate once per year. When the polymer of the present invention is used, the intervals between irrigation cycles can be longer than the intervals between irrigation cycles when the polymer is not used, the length of the irrigation cycles can be shorter than when the polymer is not used and/or the health of the turf will be improved compared to turf irrigated the same amount without the polymer of the present invention. Thus, when the polymer of the present invention is applied to turf, the total amount of water applied during a specific time period, such as one month, is less than the total water applied to the turf when the polymer is not applied.

Turf treated with the polymer of the present invention via the method of the present invention has shown dramatically improved tolerance to heat and moisture stress conditions. With such performance, irrigation demands are reduced thereby saving water and energy associated with irrigation maintenance on highly managed turf, as set forth in more detail in the following example.

### EXAMPLE 1

The water-soluble polymer of the present invention was applied to established turf at a golf course in the Nevada dessert. The golf course was an 18-hole course consuming a total of 168 acres. In the initial application, the 9 back holes, approximately 80 acres, were treated with the water-soluble polymer of the present invention, while the front 9 holes, approximately 88 acres, were not treated. The course turf comprised Bermuda grass fairways over-seeded with rye and bent grass greens and tees.

The irrigation system at the golf course was a permanent, high pressure, high volume system, designed to irrigate all of the established turf and landscaping, including greens, fairways and tee boxes. During the heated summer months, without use of the water-soluble polymer of the present invention, irrigation cycles typically are applied every day. Each irrigation cycle delivers approximately 2.5 million gallons of water, about 1.2 million gallons for the back 9 holes.

The polymer of the present invention was supplied as concentrated emulsion, and applied at a rate of 2 quarts of polymer emulsion per acre of turf. Multiple problems with the course pumping station caused by a bad weather lightening strike prevented standard regular and consistent irrigation cycles. As a result, the course was irrigated every three to four days rather than every day while the pumping station was repaired. During this period, the 9 holes that were not treated were highly stressed as expected, but surprisingly the 9 holes that were treated with the water-soluble polymer of the present invention showed a dramatic improvement in drought and heat stress. In subsequent irrigation cycles, efforts to measure and document performance have shown typical observations of 40% dry areas on untreated turf in contrast to turf treated with the water-soluble polymer of the present invention showing less than 5% dry areas.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and sub-combinations are of utility and may be employed without reference to other features and sub-combinations. This is contemplated by and is within the scope of the claims.

What is claimed and desired to be secured by Letters Patent is as follows:

1. A method for increasing irrigation efficiency, comprising,
providing an anionic non-crosslinked polyacrylamide; and
applying said polymer to established turf.

2. The method of claim 1, wherein said turf is managed turf.

3. The method of claim 1, wherein a substantial portion of said turf is not suffering from localized dry spots.

4. The method as claimed in claim 1, wherein said polyacrylamide is a high molecular weight polymer.

5. The method of claim 1, wherein said polyacrylamide is applied at a rate of 0.3 to 12.5 pounds per 1000 square feet.

6. The method of claim 1, further comprising, after said providing step, the step of combining said polyacrylamide with water.

7. The method of claim 6, wherein said combining step is performed within an irrigation system.

8. The method of claim 7, wherein said combining step comprises injecting said polyacrylamide into said irrigation system.

9. The method of claim 1, wherein said applying step comprises applying a dry polyacrylamide.

10. A method for increasing irrigation efficiency, comprising:
providing an anionic non-crosslinked polyacrylamide;
injecting said polyacrylamide into an irrigation system to provide a water/polyacrylamide mixture; and
applying said water/polyacrylamide mixture to established turf.

11. The method of claim 10, further comprising the step of repeating said applying step at regular intervals.

12. The method of claim 11, wherein said regular intervals are about every thirty days.

13. The method of claim 11, wherein said regular intervals are about every two weeks.

14. The method of claim 11, further comprising conducting irrigation cycles without said polyacrylamide between said applying steps, wherein the time between each of said irrigation cycles is longer than the time between standard irrigation cycles for said turf when said polyacrylamide has not been applied.

15. The method of claim 11, further comprising the step of conducting irrigation cycles without said polyacrylamide between said applying steps, wherein the length of each of said irrigation cycles is shorter than the length of standard irrigation cycles for said turf when said polyacrylamide has not been applied.

16. The method of claim 11, further comprising the step of conducting irrigation cycles without said polyacrylamide between said applying steps, wherein the total water applied during said irrigation cycles over one month is less than the total water applied during standard irrigation cycles for said turf during one month when said polyacrylamide has not been applied.

17. A method for increasing irrigation efficiency, comprising,
providing an anionic linear polyacrylamide; and
applying said polymer to established turf, wherein said applying step results in increased irrigation efficiency.

18. The method of claim 17, wherein said polyacrylamide is provided as an emulsion.
